(19) United States
(12) Patent Application Publication
(10) Pub. No.: US 2010/0134402 A1
(43) Pub. Date: Jun. 3, 2010

(54) SCANNING BACKLIGHT LCD PANEL WITH OPTIMIZED LAMP SEGMENTATION AND TIMING

(75) Inventor: Hendrikus Willem Groot Hulze, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,838

(22) PCT Filed: Mar. 24, 2006
(86) PCT No.: PCT/IB2006/050913

§ 371 Date: Sep. 27, 2007

(30) Foreign Application Priority Data
Apr. 1, 2005 (EP) 05102607.8

(51) Int. Cl. G09G 3/36

(52) U.S. Cl. 345/102

(57) ABSTRACT

A liquid crystal display (1100) is disclosed, comprising a liquid crystal display panel (1102), a backlight unit, and a controller (1104, 1200, 1300). The liquid crystal display panel (1102) comprises a plurality of picture elements, wherein said picture elements are refreshed repeatedly, said backlight unit comprises a plurality of lighting devices (1105) each associated with a section of the display panel (1102) and arranged to provide backlighting to said section of the display panel (1102), and said controller (1104, 1200, 1300) is arranged to control timing, between refresh of picture elements and said backlighting by the lighting device corresponding to the section of the picture elements to be refreshed, in dependence on a position of the section associated with said corresponding lighting device. The controller comprises a backlighting controller for each of said sections, which backlighting controller is arranged to control backlighting timing depending on said position of said each section, wherein said control of backlighting timing comprises an advance, related to a refresh timing of corresponding picture elements, of backlighting timing for sections at a first end of said display panel, and a delay, related to a refresh timing of corresponding picture elements, of backlighting timing at a section at a second end opposite to said first end of said display panel (1102). Further, a method for displaying images on such a display is disclosed.

### TECHNICAL FIELD

The present invention relates to a liquid crystal display and a method for displaying images.

### BACKGROUND OF THE INVENTION

LCD (Liquid Crystal Display) panels suffer from motion blur due to their sample-and-hold nature, i.e. the LC (Liquid Crystal) remains in the same state after addressing during a whole frame. When displayed objects move, as is the case in e.g. TV images, this causes a blurred image of the objects on the retina of a viewer. Flashing the backlight solves the sample-and-hold effect because a light pulse exposures the display panel for a short time every frame. By segmentation of the backlight and by linking the timing of the flash of each segment to the sequential addressing scheme of the display panel, a light pulse scans the picture. This is normally called scrolling or scanning backlight.

In US 2002/0067332 A1, it is disclosed a liquid crystal display device having a backlight arrangement comprising six light sources each arranged to backlight a part of the display. A problem is pointed out that if lighting and extinguishing is performed equally for all light sources, a profile of an image displayed at upper and lower side portions appear in duplicate.

This is solved, according to US 2002/0067332 A1, either by always having the uppermost and lowermost light sources lit, or by shifting the phase for lighting and extinguishing the uppermost and lowermost light sources, or increasing the frequency for lighting and extinguishing the uppermost and lowermost light sources, or decreasing the supply current for the uppermost and lowermost light sources, or spacing the uppermost and lowermost light sources apart from neighboring light sources, or applying a different duty cycle for lighting and extinguishing the uppermost and lowermost light sources compared to other light sources of the backlighting arrangement.

However, the effectiveness of these measure appears to be limited in practice, and therefore there is a need for an improved backlight control to avoid a blurred image.

### SUMMARY OF THE INVENTION

It is therefore an object of the present invention to provide an improved display, and improved method for displaying images on a display.

The present invention is based on the understanding that effective illumination of a display deviates from backlight timing according to a given backlight input signal due to the backlight optics cross talk of light between the segments in combination with a LC-transmission effect.

The above object is achieved according to a first aspect of the present invention by a liquid crystal display according to the independent Claim 1. Further advantageous embodiments are defined in the dependent Claims. An advantage of this liquid crystal display is improved image quality, especially far from the center of the display, due to improved timing between backlighting of a section of the display panel and refresh of corresponding pixels within that section. These functions do not have to be linear or symmetrical.

A controller is provided for controlling a timing between backlighting and pixel refresh, in dependence of a location of a section within the display panel.

This controller is preferably arranged for providing an advance in timing of backlighting for sections at a first end of the display panel, with respect to refreshing of pixel in these sections, and for providing a delay in timing of backlighting for sections at a second end of the display panel opposite to the first end, with respect to the refreshing of pixels in these sections.

The advance for each section at said first end may be an increasing function of a distance of said each section from a center of the display, and the delay for each section at said other end may be an increasing function of a distance of said each section from the center of the display.

An advantage of these ways to control backlight timing where effective backlight timing is considered is accurate backlighting in relation to refresh of corresponding pixels to reduce risk for pre-ghost and post-ghost images.

The controller may comprise a refresh timing controller arranged to control timing of said refresh of picture elements in relation to said backlighting depending on a location of a picture element to be refreshed within the display panel.

The control of said refresh timing may comprise a delay, related to a backlighting timing of corresponding picture elements, of refresh timing at a position at a first end of said display panel, and an advance, related to a backlighting timing of corresponding picture elements, of refresh timing at a position at a second end opposite to said first end of said display panel.

The advance of refresh timing at said first end may be an increasing function of a distance of corresponding picture element from a center of the display, and the delay of refresh timing at said other end may be an increasing function of a distance of corresponding picture element from the center of the display.

An advantage of these ways to control refresh timing in relation to effective backlight timing is reduced risk for pre-ghost and post-ghost images.

Distribution of lighting devices and size of each of said sections associated with any of said lighting devices may depend on said position of said each section.

An advantage of this is an optimized design of the backlighting unit to reduce risk for pre-ghost and post-ghost images.

The above object is achieved according to a second aspect of the present invention by a method for displaying images on a display comprising a display panel and a backlight unit, wherein the backlight unit comprises a plurality of lighting devices each associated with a section of the display panel to provide a backlighting to the corresponding section of the display panel, comprising the steps of refreshing picture elements of the display panel repeatedly; backlighting each of the sections of the display panel corresponding to the refresh of the picture elements; and controlling timing between the refreshing and the backlighting depending on a corresponding position on the display.

The controlling of timing may comprise the step of controlling backlighting timing for each section.

The step of controlling backlighting timing may comprise the steps of

advancing, related to a refresh timing of corresponding picture elements, backlighting timing for sections at a first end of said display panel; and

delaying, related to a refresh timing of corresponding picture elements, backlighting timing for sections at a second end opposite to said first end of said display panel.

The advance for each section at said first end may be an increasing function of a distance of said each section from a center of the display, and the delay for each section at said other end may be an increasing function of a distance of said each section from the center of the display.

The controlling of timing may comprise the step of controlling refresh timing.

The step of controlling refresh timing may comprise the steps of: delaying refresh timing for picture elements at a first end of said display panel; and advancing refresh timing for picture elements at a second end opposite to said first end of said display panel.

The delay of refresh timing for picture elements at said first end may be an increasing function of a distance of picture elements from a center of the display, and the advance of refresh timing for picture elements at said other end may be an increasing function of a distance of picture elements from the center of the display.

Advantages of the second aspect of the present invention are similar to those of the first aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 is a time versus light signal diagram for an exemplary backlight pulse of a single lamp or segment without the influence of neighboring lamps;

FIG. 2 is a diagram illustrating an LC-transmission curve;

FIG. 3 is a time versus light signal diagram for an exemplary effective backlight pulse;

FIG. 4 is a diagram showing refresh timing of pixels and backlight scanning illustrated by position on the screen versus time according to prior art;

FIG. 5 is a diagram showing refresh timing of pixels and backlight scanning illustrated by position on the screen versus time according to an embodiment of the present invention;

FIG. 6 is a diagram showing refresh timing of pixels and backlight scanning illustrated by position on the screen versus time according to an embodiment of the present invention;

FIG. 7 is a diagram showing refresh timing of pixels and backlight scanning illustrated by position on the screen versus time according to an embodiment of the present invention;

FIG. 8 is a diagram showing refresh timing of pixels and backlight scanning illustrated by position on the screen versus time according to an embodiment of the present invention;

FIG. 9 is a diagram showing refresh timing of pixels and backlight scanning illustrated by position on the screen versus time according to an embodiment of the present invention;

FIG. 10 is a diagram showing refresh timing of pixels and backlight scanning illustrated by position on the screen versus time according to an embodiment of the present invention;

FIG. 11 illustrates a display according to an embodiment of the present invention;

FIG. 12 is a block diagram schematically illustrating a backlight controller according to an embodiment of the present invention;

FIG. 13 is a block diagram schematically illustrating a backlight controller according to an embodiment of the present invention; and

FIG. 14 illustrates the influence of cross talk between segments.

### DETAILED DESCRIPTION OF PREFERRED EMBODIMENTS

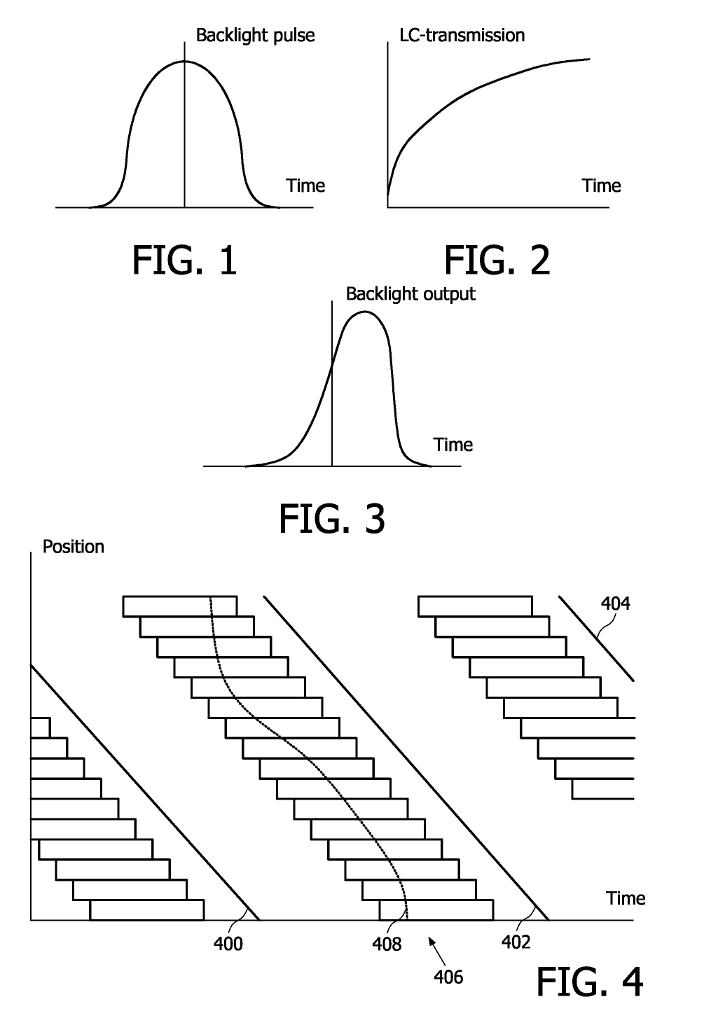

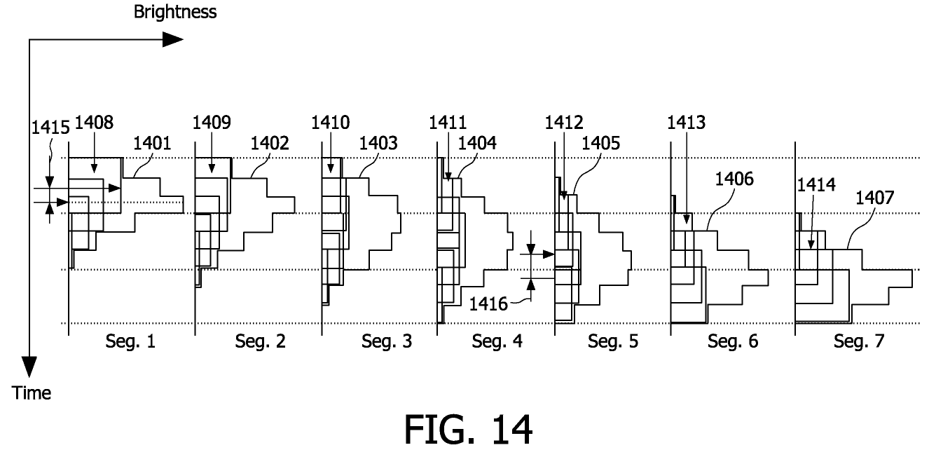

FIG. 1 is a time versus light signal diagram for an exemplary backlight pulse. In this case the backlight pulse is symmetric, but any pulse shape is possible, e.g. an asymmetrical pulse. However, the effect, described below, that an effective backlight pulse will have another shape than the intended backlight pulse, still applies. Current backlight designs have no perfect segmentation. Due to cross talk of light pulses of neighboring segments, the scan pulse is the summation of several light pulses from close-by lamps. As a result, the shape and phase of the scan pulse is screen position dependent, as illustrated in FIG. 14. As is pointed out in FIG. 14, the scanning light pulse is the summation 1401-1407 of the effect 1408-1414 of all lamps. This is vertical position dependent, i.e. dependent on the actual segment. The consequence of the poor segmentation is an asymmetrical scanning pulse at the top and bottom of the screen. Hence “the center of gravity” of the light pulse shifts in time and is no longer in phase with the addressing scheme of the panel, i.e. the refresh of pixels. In practice the shape of the light pulse is even more complicated due to non-gaussian light distribution and turn on and off behavior of the lamps. The duty cycle has a big influence on the shape of the light pulse as well but not or hardly on the curve of the effective sampling moment. As a result of the light pulse shift the amplitude of the ghost images will change over the vertical position of the screen. Therefore, for the top segments, the effective sampling moment is delayed 1415 due to poor segmentation, and the effective sampling moment is earlier for bottom segments, i.e. less delay 1416.

FIG. 2 is a diagram illustrating an LC-transmission curve, which the observed light pulse is affected by. Therefore, an effective panel illumination output, as depicted by FIG. 3, will have a reformed shape, in this example the symmetrical backlight pulse of FIG. 1 has become an asymmetrical effective panel illumination output as depicted in FIG. 3.

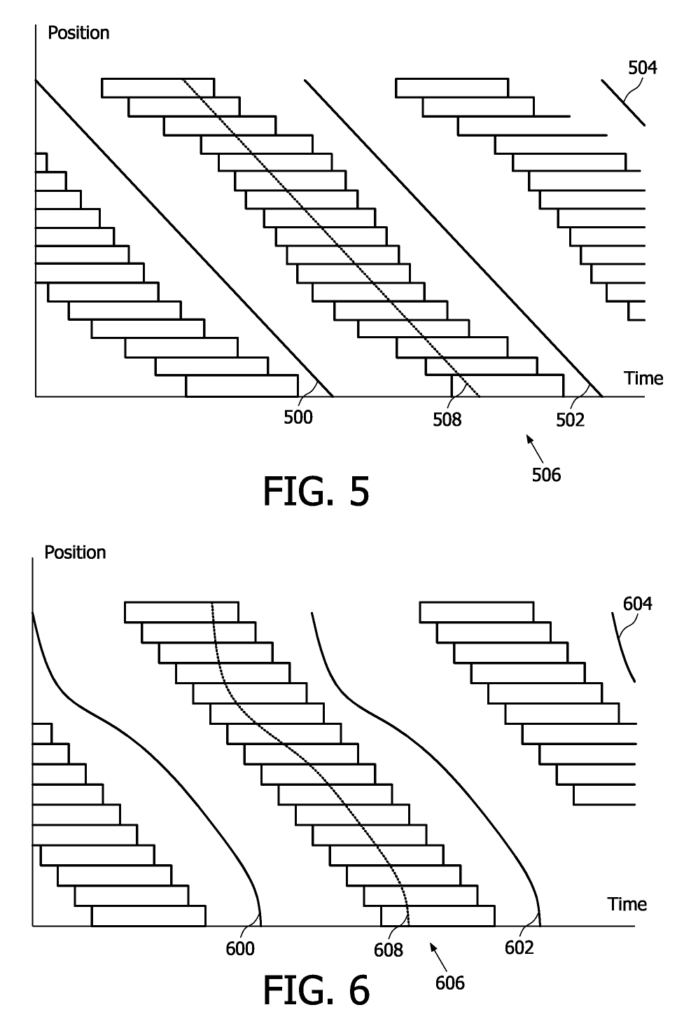

FIG. 4 is a diagram showing refresh timing of pixels and backlight scanning illustrated by position on the screen versus time according to prior art. The repeated pixel refresh timing for each position at each time form lines 400, 402, 404 in the diagram. A backlight unit comprises a plurality of lighting devices, each associated with a section of the display, i.e. associated with a range of positions, where the activation of the lighting devices are depicted by blocks 406. The activation signal for each lighting device is depicted as a block, where the duration of the activation signal is the prolongation in time direction of the block, and the positions covered by the lighting device is the extension in position direction of the block. In practice there is overlap in vertical direction of the blocks due to poor segmentation. Preferably, the backlight of the display is scanned to, with a time offset, synchronized with the refresh of pixels. The time offset should be such that there is as much time as possible from the previous refresh until lighting the backlight to avoid post-ghost images due to the slow settlement of the liquid crystal, and a proper time distance between the extinguishing of the backlight before next refresh to avoid pre-ghost images. However, due to cross talk of segments in the backlight, the effective backlighting is, as depicted by the dotted line 408. As can be seen from the diagram of FIG. 4, the effective backlighting timing 408 does not coincide with a constant offset to the next refresh 402. This is problem due to the LC-transmission curve described in FIG. 2. An approximation of the timing has to be done at the design, e.g. where a proper offset is achieved for positions in the middle of the display, and a tangible deviation from the proper offset is present at the end positions on the display. In the present example, there is a risk for pre-ghost images at a first end, e.g. the top of the display when scanned from top to bottom, while there is a risk for post-ghost images at the other end of the display. The present invention, as discussed in connection with FIGS. 5, 6, and 7, present embodiments for providing a proper offset between the effective backlighting timing and the refresh timing for the entire display. Especially in combination with over-drive to suppress post-ghosts a constant offset is required.

FIG. 5 is a diagram showing refresh timing of pixels and backlight scanning illustrated by position on the screen versus time according to an embodiment of the present invention. The repeated pixel refresh timing for each position at each time form lines 500, 502, 504 in the diagram. A backlight unit comprises a plurality of lighting devices, each associated with a section of the display, i.e. associated with a range of positions, where the activation of the lighting devices are depicted by blocks 506. The activation signal for each lighting device is depicted as a block, where the duration of the activation signal is the prolongation in time direction of the block, and the positions covered by the lighting device is the extension in position direction of the block. Preferably, the backlight of the display is scanned to, with a time offset, coincide with the refresh of pixels. However, in this embodiment, the timing of the backlighting is adapted to comprise a lag at positions at a first end of the display and to comprise a lead at positions at the other end. Due to the crosstalk, as described in connection with FIG. 14, the effective backlighting timing now form a linear timing characteristic, as depicted by the dotted line 508.

As can be seen from the diagram of FIG. 5, the effective backlighting timing 508 coincides with a constant offset to the next refresh 502. Thus, the risk for ghost images is reduced. If overdrive is not implemented it is best not to optimize for a constant offset but for the smallest local offset without pre-ghosts. Hence, the top segments can be delayed less, or not at all, because at the top the lamp can not introduce a pre-ghost due to light cross talk to a segment above it.

FIG. 6 is a diagram showing refresh timing of pixels and backlight scanning illustrated by position on the screen versus time according to an embodiment of the present invention. A backlight unit comprises a plurality of lighting devices, each associated with a section of the display, i.e. associated with a range of positions, where the activation of the lighting devices are depicted by blocks 606. The activation signal for each lighting device is depicted as a block, where the duration of the activation signal is the prolongation in time direction of the block, and the positions covered by the lighting device is the extension in position direction of the block. Preferably, the backlight of the display is scanned to, with a time offset, coincide with refresh of pixels. However, in this embodiment, the timing of the refresh of pixels is adapted to comprise a lead at positions at a first end of the display and to comprise a lag at positions at the other end. Therefore, the repeated pixel refresh timing for each position at each time form curved lines 600, 602, 604 in the diagram. As can be seen from the diagram of FIG. 6, the effective backlighting timing 608 coincides with a constant offset to the refresh 602, since the curved timing characteristics form a similar curvature. Thus, the risk for ghost images is reduced.

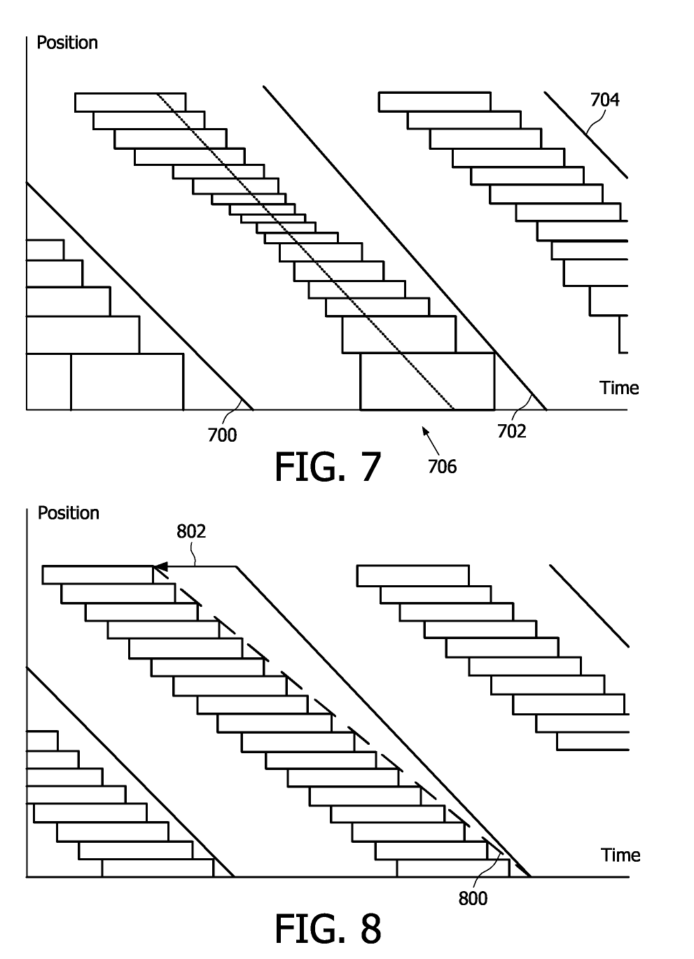

FIG. 7 is a diagram showing refresh timing of pixels and backlight scanning illustrated by position on the screen versus time according to an embodiment of the present invention. The repeated pixel refresh timing for each position at each time form lines 700, 702, 704 in the diagram. A backlight unit comprises a plurality of lighting devices, each associated with a section of the display, i.e. associated with a range of positions, where the activation of the lighting devices are depicted by blocks 706. The activation signal for each lighting device is depicted as a block, where the duration of the activation signal is the prolongation in time direction of the block, and the positions covered by the lighting device is the extension in position direction of the block. Preferably, the backlight of the display is scanned to, with a time offset, coincide with the refresh of pixels. However, in this embodiment, the sizes of the lighting devices and the corresponding sections are adapted to comprise medium sizes at positions at a first end of the display, small sizes at positions in the middle, and larger sizes at positions at the other end. Due to the crosstalk, as described in connection with FIG. 14, the effective backlighting timing now form a linear timing characteristic, as depicted by the dotted line 708. As can be seen from the diagram of FIG. 7, the effective backlighting timing 708 coincides with a constant offset to the refresh 702. In case the smaller segments in the center of the backlight are implemented by placing more, e.g. identical, lamps closer together, the local light output will increase. Hence the duty cycle of the lamps should be reduced, e.g. proportional to the locale lamp distance. Shorter duty cycles and smaller segments will both shorten the effective scan pulse, hence a sharper moving picture will be experienced in the center of the screen.

The principles depicted in the embodiments depicted in FIGS. 5, 6, and 7 can be applied in any combination to form suitable refresh timing characteristics and backlighting characteristics, and thereby achieve a proper offset between effective backlighting timing and pixel refresh timing.

FIG. 8 is a diagram showing refresh timing of pixels and backlight scanning illustrated by position on the screen versus time according to an embodiment of the present invention. To provide a simple implementation, reduced scan speed 800 of the backlight is provided together with a pre-delay 802 at a first end of the display. Thus, the risk of pre-ghost images is reduced at the first end of the display, and the risk of post-ghost images is reduced at the other end.

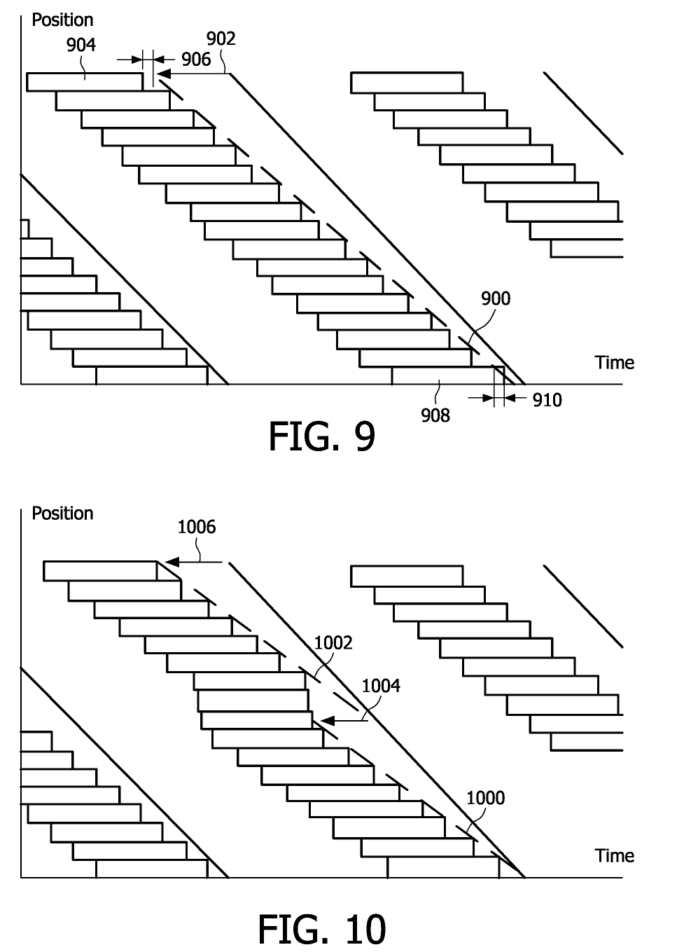

FIG. 9 is a diagram showing refresh timing of pixels and backlight scanning illustrated by position on the screen versus time according to an embodiment of the present invention. To provide a simple implementation, reduced scan speed 900 of the backlight is provided together with a pre-delay 902 at a first end of the display. Further, the first and last lighting devices are provided with an extra time shift to further reduce the risk of pre-ghost images at the first end of the display, and the risk of post-ghost images at the other end. Therefore, a first lighting block 904 is advanced in time with a time advance 906, and a last lighting block 908 is delayed with a delay 910.

FIG. 10 is a diagram showing refresh timing of pixels and backlight scanning illustrated by position on the screen versus time according to an embodiment of the present invention. To provide a simple implementation, reduced scan speed 1000, 1002 of the backlight is provided in two steps together with pre-delay 1004, 1006. Thus, the risk of pre-ghost images is reduced at the first end of the display, and the risk of post-ghost images is reduced at the other end, while a proper timing is achieved at positions in the middle of the display.

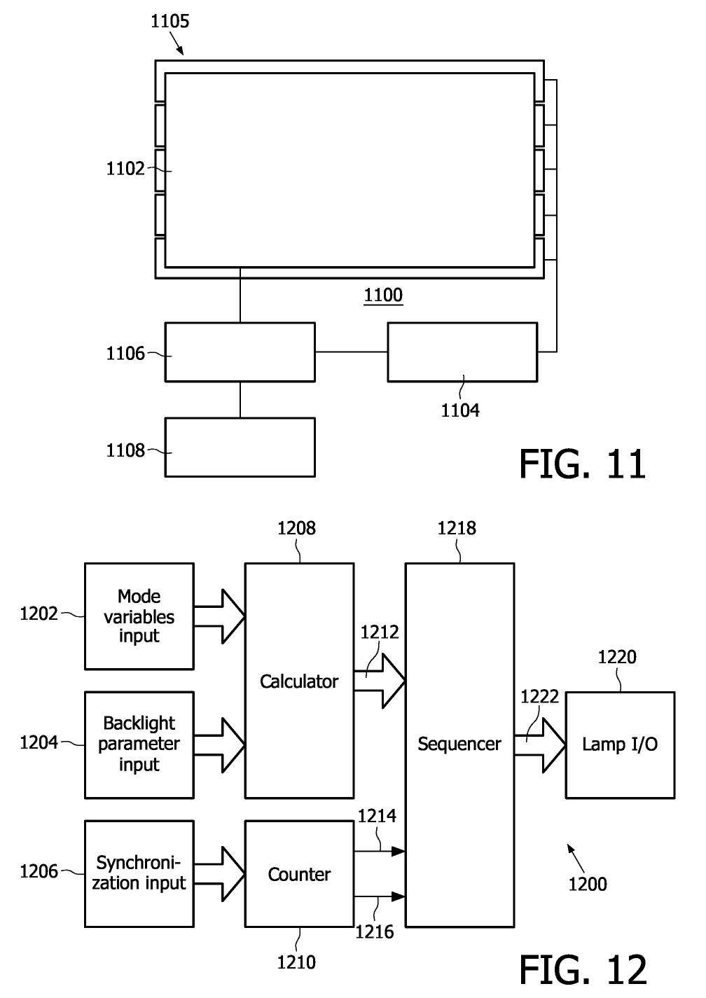

FIG. 11 illustrates a display 1100 comprising a display panel 1102. The display panel 1102, which can be a LCD (Liquid Crystal Display) panel, is provided with a plurality of lighting devices 1105. Each of the lighting devices 1105 can for example comprise one or more lighting sources, such as light emitting diodes (LEDs) or gas discharge lamps. The backlight is flashed by scanning lighting devices 1105. Thus, an LC cell is illuminated only for a certain fraction of the frame time. A backlight controller 1104, which is connected to the lighting devices 1105 of the panel 1102, controls backlight flashing. To avoid ghost images, the backlight controller 1104 provides backlight control signals which are dependent on the position of an associated part of the panel 1102. Therefore, the backlight controller is connected to a display controller 1106, which in turn receives image data from an image data source 1108. It should be noted that this description is for illustrative purpose, and both the backlight controller 1104 and the display controller 1106 can be a common video controller, or divided between two or more units, which provide the same function as the backlight and display controllers 1104, 1106. The data source 1108 can be a TV decoder, a DVD player, a computer, or any other means providing images to be viewed on the display 1100.

FIG. 12 is a block diagram schematically illustrating a backlight controller 1200 according to an embodiment of the present invention. The backlight controller 1200 comprises a mode variables input 1202, a backlight parameter input 1204, and a synchronization input 1206. The inputs 1202, 1204, 1206 receive information from a video controller. The mode variables input 1202 receives information on number of lines, blanking, and/or front porch. The backlight parameter input 1204 receives information on lamp distance, scan speed, pre-delay, and/or light distribution curve. The synchronization input receives information on horizontal synchronization, vertical synchronization, and/or data enable.

The backlight controller 1200 further comprises a calculator 1208 and a counter 1210. The mode variables input 1202 and the backlight parameter input 1204 is connected to the calculator 1208 for providing information, such that the calculator can calculate lamp turn-off data 1212. The Synchronization input is connected to the counter 1210 to enable the counter to provide row number 1214 and pixel number 1216.

The backlight controller further comprises a sequencer 1218 and a lamp I/O 1220. The lamp turn-off data 1212, the row number 1214, and the pixel number 1216 is provided to the sequencer 1218. The sequencer 1218 calculates the turn-on data offset and provides control information 1222 to the lamp I/O 1220 according to any of the principles described in connection with FIGS. 5-10, or any combination of those principles, to provide improved backlighting for reduced ghost images. The lamp I/O controls the flashing of the lighting devices 1105 in FIG. 11 according to the control information 1222.

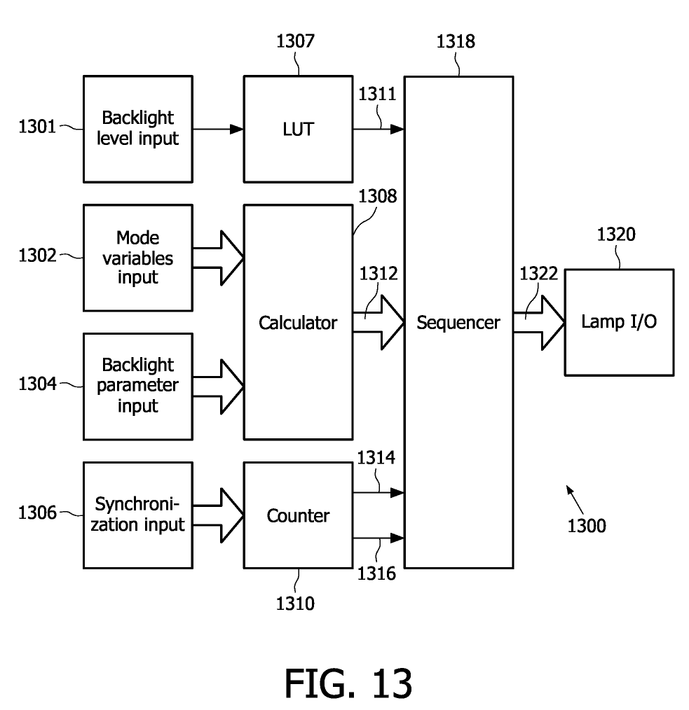

FIG. 13 is a block diagram schematically illustrating a backlight controller 1300 according to an embodiment of the present invention. The backlight controller 1300 comprises a backlight level input 1301, a mode variables input 1302, a backlight parameter input 1304, and a synchronization input 1306. The inputs 1301, 1302, 1304, 1306 receive information from a video controller. The backlight level input 1301 receives information on dynamic light output. The mode variables input 1302 receives information on number of lines, blanking, and/or front porch. The backlight parameter input 1304 receives information on lamp distance, scan speed, pre-delay, and/or light distribution curve. The synchronization input receives information on horizontal synchronization, vertical synchronization, and/or data enable.

The backlight controller 1300 further comprises a look-up table (LUT) 1307, a calculator 1308 and a counter 1310. The backlight level input 1301 is connected to the LUT 1307 for providing information on dynamic backlighting, such as reduced lamp duty cycle, which can be symmetric or asymmetric to provide a dynamic backlighting signal 1311. The mode variables input 1302 and the backlight parameter input 1304 is connected to the calculator 1308 for providing information, such that the calculator can calculate lamp turn-off data 1312. The Synchronization input is connected to the counter 1310 to enable the counter to provide row number 1314 and pixel number 1316.

The backlight controller further comprises a sequencer 1318 and a lamp I/O 1320. The dynamic backlight signal 1311, the lamp turn-off data 1313, the row number 1314, and the pixel number 1316 is provided to the sequencer 1318. The sequencer 1318 provides control information 1322 to the lamp I/O 1320 according to any of the principles described in connection with FIGS. 5-10, or any combination of those principles, to provide improved backlighting for reduced ghost images. The lamp I/O controls the flashing of the lighting devices 1105 in FIG. 11 according to the control information 1322.

1. A liquid crystal display (1100), comprising:
a liquid crystal display panel (1102) including a plurality of picture elements;
a backlight unit comprising a plurality of lighting devices (1105) each associated with a section of the display panel (1102) and arranged to provide backlighting to said section of the display panel (1102), and
a controller (1104, 1200, 1300) for controlling a timing between refresh of picture elements and backlighting of the section of the picture elements to be refreshed, in dependence on a position of the section associated with said corresponding lighting device.

2. The display according to claim 1, wherein the controller is arranged for providing, an advance of backlighting timing for sections at a first end of said display panel, and a delay of backlighting timing for sections at a second end opposite to said first end of said display panel (1102), relative to a refresh timing of corresponding picture elements.

3. The display according to claim 2, wherein said advance for each section at said first end is an increasing function of a distance of said each section from a center of the display, and said delay for each section at said other end is an increasing function of a distance of said each section from the center of the display.

4. The display according to claim 1, wherein said controller (1104, 1200, 1300) comprises a refresh timing controller arranged to control timing of said refresh of picture elements in relation to said backlighting depending on a location of a picture element within the display panel.

5. The display according to claim 4, wherein said control of said refresh timing comprises a delay, related to a backlighting timing of corresponding picture elements, of refresh timing at a position at a first end of said display panel, and an advance, related to a backlighting timing of corresponding picture elements, of refresh timing at a position at a second end opposite to said first end of said display panel (1102).

6. The display according to claim 5, wherein said advance of refresh timing at said first end is an increasing function of a distance of corresponding picture element from a center of the display, and said delay of refresh timing at said other end is an increasing function of a distance of corresponding picture element from the center of the display.

7. The display according to claim 1, wherein distribution of lighting devices and size of each of said sections associated with any of said lighting devices (1105) depend on a location of a section within the display panel.

8. A method for displaying images on a liquid crystal display comprising a liquid crystal display panel and a backlight unit, wherein said backlight unit comprises a plurality of lighting devices each associated with a section of said display panel to provide a backlighting to said corresponding section of said display panel, comprising the steps of:
refreshing picture elements of said display panel repeatedly;
backlighting each of said sections of said display panel corresponding to said refreshing of said picture elements; and
controlling timing between said refreshing and said backlighting depending on a corresponding position on the display.

9. The method according to claim 8, wherein said controlling of timing comprises the step of controlling backlighting timing for each section.

10. The method according to claim 9, wherein said step of controlling backlighting timing comprises the steps of:
advancing, related to a refresh timing of corresponding picture elements, backlighting timing for sections at a first end of said display panel; and
delaying, related to a refresh timing of corresponding picture elements, backlighting timing for sections at a second end opposite to said first end of said display panel.

11. The method according to claim 10, wherein said advance for each section at said first end is an increasing function of a distance of said each section from a center of the display, and said delay for each section at said other end is an increasing function of a distance of said each section from the center of the display.

12. The method according to claim 8, wherein said timing controlling comprises the step of controlling refresh timing of picture elements of the display panel.

13. The method according to claim 12, wherein said step of controlling refresh timing comprises the steps of:
delaying refresh timing for picture elements at a first end of said display panel; and
advancing refresh timing for picture elements at a second end opposite to said first end of said display panel.

14. The method according to claim 13, wherein said delay of refresh timing for picture elements at said first end is an increasing function of a distance of picture elements from a center of the display, and said advance of refresh timing for picture elements at said other end is an increasing function of a distance of picture elements from the center of the display.
